(19) United States
(12) Patent Application Publication
(10) Pub. No.: US 2024/0375137 A1
(43) Pub. Date: Nov. 14, 2024

(54) DEVICE FOR DISPENSING A FLUID SUBSTANCE

(71) Applicant: LUMSON S.p.A., Capergnanica (CR) (IT)

(72) Inventor: Matteo MORETTI, Crema (CR) (IT)

(21) Appl. No.: 18/657,484

(22) Filed: May 7, 2024

(30) Foreign Application Priority Data
May 8, 2023 (IT) 102023000009147

(51) Int. Cl. B05B 11/10

(52) U.S. Cl. CPC B05B 11/1047

(57) ABSTRACT

A device for dispensing a fluid substance having a cup-shaped outer container of glass, metal, or wood, and featuring a bottom and side wall with a free end determining an opening in the outer container and stably secured to a collar, the device having a plastic intermediate element supporting at least one inner container and a manual pump coupled to the inner container, to deliver a substance contained therein, with removable fastening means between the collar and the intermediate element, so that, upon dispensing all fluid substance, a user can uncouple the collar from the intermediate element taking the inner container and the pump therewith, and can replace the said intermediate element, container, and pump with a new intermediate element with a pump and inner container filled with the fluid substance by re-coupling the new intermediate element, container, and pump to the collar and therefore to the outer container.

This application claims priority to Italian Patent Application for Invention No. 102023000009147 filed on May 8, 2023, the disclosure of which is hereby incorporated by reference.

### FIELD OF THE INVENTION

The present invention relates to a fluid substance dispensing device.

In particular it refers to a refillable fluid substance dispensing device.

### STATE OF THE ART

Most of the devices on the market, which allow the dispensing of a fluid substance via a manual pump, especially in the cosmetic or medical field, are thrown away once the substance contained therein is finished.

There are also commonly known devices that offer the possibility of refills. But this filling is often laborious and difficult to carry out for end users, who are unskilled in the handling of such devices.

### SUMMARY OF THE INVENTION

The object of the present invention is to provide a device which is improved compared with the prior art.

A further object of the invention is to provide a device within everyone's reach that allows easy refilling, without having to carry out overly laborious processes.

This and other objects are achieved by means of a dispensing device according to the technical teachings of the claims appended hereto.

### BRIEF DESCRIPTION OF THE FIGURES

Further features and advantages of the innovation will become clearer in the description of a preferred but not exclusive embodiment of the device, illustrated—by way of a non-limiting example—in the drawings appended hereto, in which:

FIG. 1 is a sectional view of the device according to the present invention;

FIG. 2 is an enlargement of the part circled in FIG. 1;

FIG. 3 shows the same part as FIG. 2 but in a different embodiment;

FIG. 4 is a perspective view of an intermediate element of the device in FIG. 1;

FIG. 5 shows a part of the device in FIG. 1 in a sectional view;

FIG. 6 is a top-down view of the part in FIG. 5;

FIG. 7 is a sectional view of a variant of the device in FIG. 1;

FIG. 8 is an enlargement of the part circled in FIG. 7; and

FIG. 9 is a sectional view of a part of the device in FIG. 7.

### DETAILED DESCRIPTION OF THE INVENTION

With reference to the figures stated, reference number 1 is used to denote, as a whole, a fluid substance dispensing device.

In this document, the term ‘fluid substance’ can mean a variably dense liquid, such as a cream, which is preferably used in the cosmetic or medical fields.

The fluid substance dispensing device 1 comprises a cup-shaped outer container 2 made of glass, metal, ceramic, or wood.

The outer container 2 features a bottom 2A and a side wall 2B.

The bottom 2A and the side wall 2B are preferably made as a single piece of glass. If the outer container 2 is made of metal, wood, or ceramic, it is also possible for the side wall and the bottom to be made as two separate pieces which are subsequently assembled in an essentially immovable manner.

In any case, the side wall 2B features an end opposite the bottom which forms an opening (or mouth) in the outer container 2.

Advantageously, the side wall 2B of the outer container is cylindrical or polygonal (for example square, hexagonal, etc.). The base or bottom 2A can feature a conformation which corresponds to the perimeter of a cross-section of the side wall 2B.

Advantageously, the opening of the outer container 2 is formed at the end of the side wall 2B and has a surface area which is comparable to or greater than that of the base 2A.

The side wall 2B can therefore be tapered towards the base 2A, and therefore can be slightly frusto-conical.

The end opposite the bottom of the container 2 is stably fixed to a collar 80, whose usefulness will be clarified later.

The device 1 further comprises an intermediate element 5, 5′ made of plastic which supports at least an inner container 6 and, directly or indirectly, a hand pump 7, the latter being coupled to the inner container 6,60 for dispensing a substance S contained therein.

Removable constraint means 60A, 60B, 70A, 70B are provided between the collar 80 and the intermediate element, so that, after all the fluid substance S has been dispensed, a user can uncouple the collar 80 from the intermediate element 5 (taking the inner container 6 and the pump 7 therewith), and can replace the said components with a new intermediate element 5 plus a pump 7 and an inner container 6, 60 full of the fluid substance S to be dispensed, re-coupling the said components to the collar 80 and therefore to the outer container 2.

Therefore, removal of the intermediate element 5 also removes the inner container 60, the pump 7, and any other element except the outer container 2 and the collar 80.

Therefore, once the substance to be dispensed is finished, it is possible to keep the outer container 2 (connected to the collar 80), which can also manufacture to a very high level of quality, and re-couple the said container to a new intermediate element 5, 5′ which, supporting the pump 7 and the inner container 6, 60, essentially serves as a refill.

Therefore the opening of the outer container 2, and consequently a passage 80A in the collar 80, can be configured so as to allow an inner container 6, 60 full of fluid substance S to be dispensed to be inserted into the outer container 2. Preferably, during insertion, the passage 80A must be large enough to prevent deformation of the inner container 6.

To couple with the outer container 2, the intermediate element 5 may comprise a stop 5A, which abuts against a part of the collar 80.

The stop 5A can be, for example, a cylindrical part (FIG. 2, 3) a flange (FIG. 8) or a step.

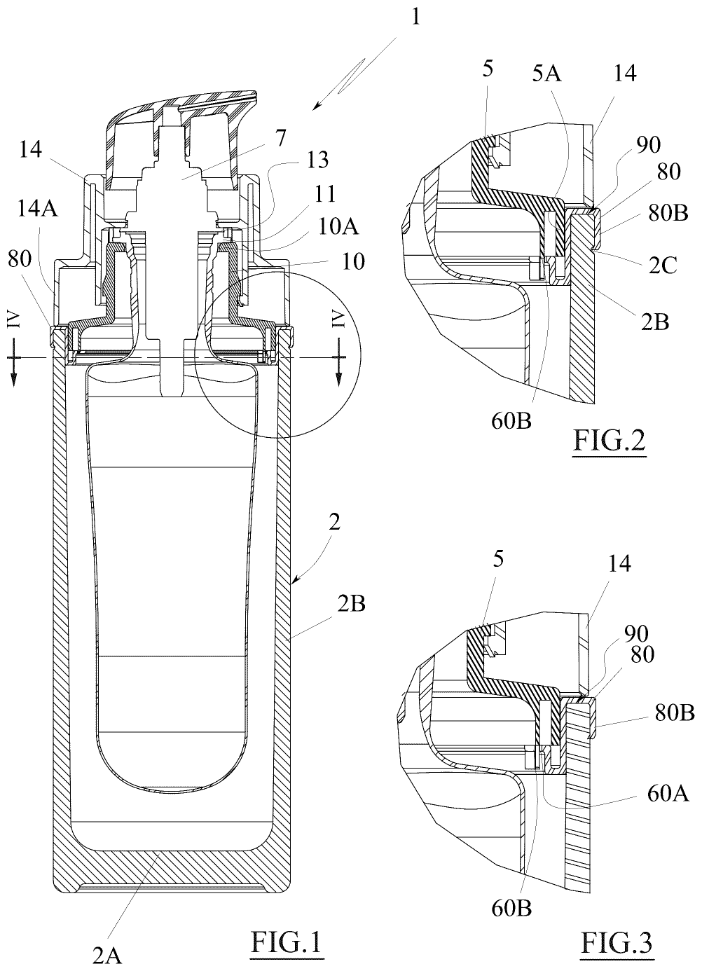

Continuing with the description relating to the configurations in FIGS. 1, 2, 3, and 4, it should be noted that the intermediate element 5 can form a neck 10 with a smaller diameter than that of the opening formed by the free end of the said side wall 2B or by the opening 80A.

The diameter of the neck 10 can be similar to that of conventional containers, precisely to allow connection with a conventional-albeit airless-pump 7.

The neck 10 can be endowed with a free end 10A on which a first flange 11 of the inner container 6 rests, the said container being a deformable bag housed in the outer container 2.

A second flange 13 of the pump 7 can rest on the first flange 11.

Obviously, a seal (not shown) can be featured between the pump and the inner container 6.

The device can also comprise a ring nut 14 locked to the said neck 10, the first flange 11 (of the bag) and the second flange 13 (of the pump) being sandwiched between the said free end 10A and the said ring nut 14.

Note that, if the ring nut 14 is present, it may feature a skirt 14A. For aesthetic reasons, the skirt 14A can be perfectly aligned with the outer perimeter of the side wall 2B, so that the coupling between the outer container 2 and the intermediate element 5 is devoid of obvious steps or changes in diameter, except the collar 80.

Therefore, the only part of the container that protrudes laterally consists of the thicker section formed by the part of the collar 80 superimposed around the perimeter of the wall 2B.

In one variant thereof, the skirt 14A can also cover the collar 80 from view, extending there above.

Obviously, the ring nut 14 can be locked to the neck 10 via a snap-fastening, as shown in FIG. 1, or with a thread (not shown).

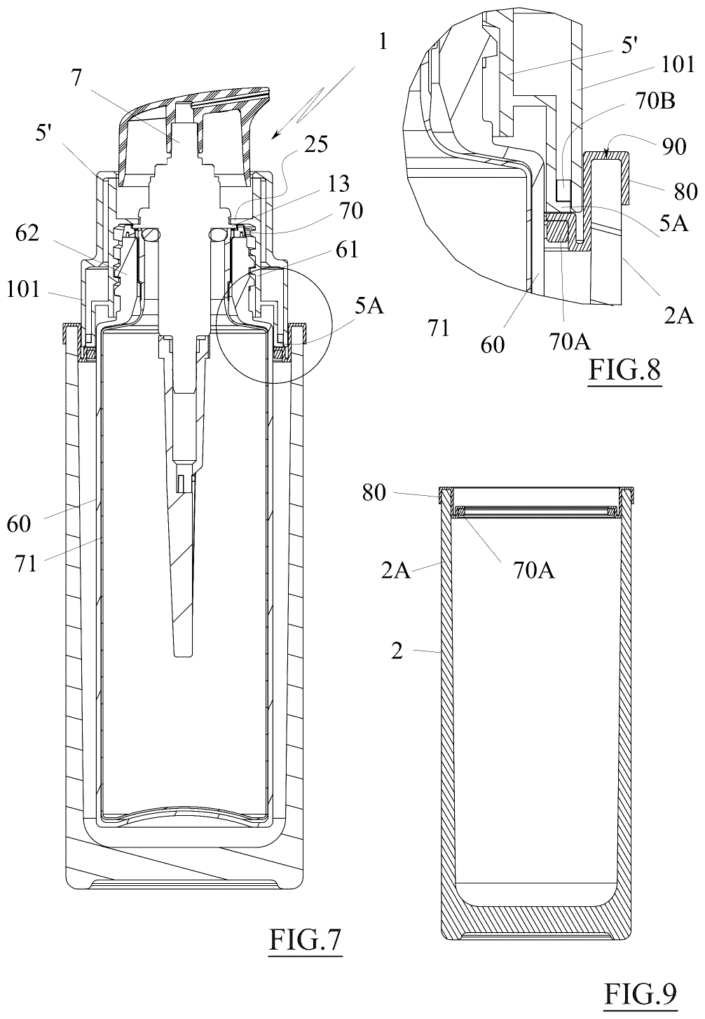

Now reference will be made to FIG. 7, which shows a slightly different configuration of the device 1.

Here, both the intermediate element 5′ and the inner container 60 have a different configuration from those illustrated previously.

The intermediate element 5′ can form a cup 61 endowed, on one of the inner walls thereof, with means for coupling the inner container 60 to a neck 62, the said neck 62 being housed in the cup 61.

It should be noted that the coupling means between the neck 62 of the inner container and the cup 61 can, alternatively, be threaded 72 or can feature a snap-fastening (not shown).

The top of the cup 61 can be formed by a flange wall 25 (bored for the passage of the pump 7).

A second flange 13 of the pump 7 can rest on the flange wall 25.

Consequently, the free end 70 of a deformable bag 71 housed in the inner container 60 can rest on the flange 13 of the pump 7, on the side opposite that on which the flange wall 25 rests. In practice, therefore, the second flange 13 of the pump and the free end 70 (which may also have a flange conformation) of the deformable bag 71 are sandwiched between the free end of the inner container 60 (at the mouth thereof) and the flange wall 25 of the intermediate element 5′.

In this configuration, the stop 5A can also be a flange 5A, as can be seen clearly in FIG. 8.

In this case, the intermediate element 5′ can have an outer skirt 101, which, for aesthetic reasons, is indented with respect to the collar 80.

It has been seen that the ring nut 14 shown in the configurations earlier is not featured in this configuration.

The different conformation of the intermediate element 5′ is designed to support an inner container 60 (with its own essentially rigid structure), which houses the deformable bag 71.

The deformable bag 71 can be a separate piece from the inner container 60 (not shown), or it can essentially be an (at least partial) inner lining which can be detached from the inner container 60 as a result of the vacuum generated by the pump 7 during use (as in FIG. 7).

Obviously, the neck 62 of the inner container 60 can feature recesses (not shown) that allow outer air into the said container as the deformable bag 71 empties.

Some possible conformations of the intermediate element 5 and 5′, and consequently of the inner container 6 and 60, are described above.

The configurations of the collar 80 and the outer container 2 that will now be described can be used indifferently with either of the configurations described in the examples above.

For example, the removable constraint means 60A, 60B can form a bayonet coupling.

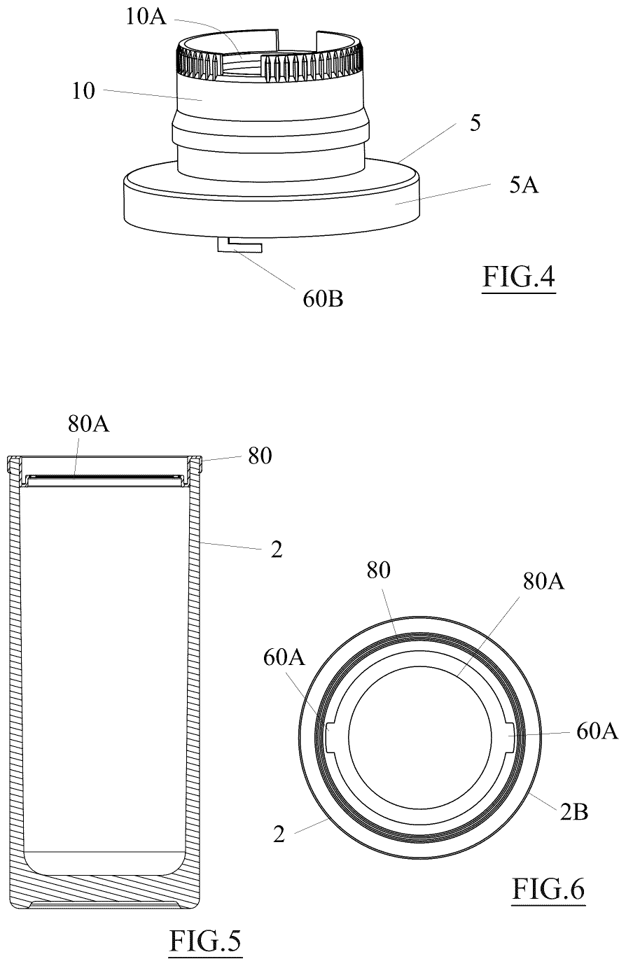

More specifically, FIG. 4 shows a fastening element 60B made on the intermediate element 5 and FIG. 6 shows the recesses 60A made in the collar into which the fastening elements 60B are inserted and fastened.

Alternatively, as in FIG. 7, the removable fastening means 70A, 70B may be a magnetic coupling, preferably formed (see FIG. 8) of at least one magnetic element 70A secured to the collar 80 and at least one magnetic or ferromagnetic element 70B secured to the intermediate element 5.

It is preferable (but not obligatory) for the magnetic element 70A to be coupled to the collar 80 rather than the intermediate element, since the intermediate element must be handled, during assembly, by automatic machines. Mounting the magnet could therefore interfere with these automatic operations.

As regards the form of the magnetic element 70A, this may be a single ring or two mutually coupled half-rings.

In this case there is no constraint on the shape of the ferromagnetic or magnetic element 70B; it can also be made in sectors, since—with this configuration—it is not necessary to rotate or orientate the outer container with respect to the intermediate element 5.

Obviously, the mirror configuration—in which the ferromagnetic element is a ring—is also possible, and therefore the magnetic element can also be made of several mutually spaced pieces.

It should be underlined that the collar 80 can also act as a connection system between an intermediate element, for example with a square plan and an outer container with a circular plan, or vice-versa. In this case, the magnetic or ferromagnetic elements can be in sectors, since orientation between the two parts is still necessary.

The system fastening the collar 80 and the outer container 2 can also be a different kind, regardless of the system used for fastening the intermediate element 5, 5′ and the said collar 80.

For example, the collar 80 can feature, sectionally, a groove 90 into which the free edge of the said side wall 2B is inserted. This configuration is visible in both FIGS. 2 and 3, but also in FIG. 8.

The outer skirt 80B of the collar 80 can be crimped to an outer surface of the said side wall 2B (as in FIG. 3), optionally at an annular groove 2C in the said wall 2B (as in FIG. 2).

Alternatively, or in addition to the systems described above, the side wall 2B can simply be interference-fitted (but immovably, in any case) into the said groove 90. This is the specific case in FIG. 8, where there is no crimping.

Possibly, in the event that there is no crimping, an adhesive can be inserted between the side wall 2B and the collar 80.

Various embodiments of the innovation have been disclosed herein, but further embodiments may also be conceived using the same innovative concept.

1. A dispensing device (1) of a fluid substance, comprising an outer container (2) that is cup shaped and made of glass, metal, ceramic or wood, the outer container (2) presenting a bottom (2A) and a side wall (2B), the side wall (2B) presenting a free end (3) defining an opening (4) of the outer container (2), the free end (3) of the container being stably attached to a collar (80), the device (1) further comprising a plastic intermediate member (5, 5′) supporting at least one inner container (6) and, directly or indirectly, a hand pump (7) coupled to the inner container (6, 60), for dispensing a substance(S) contained therein, between the collar (80) and the intermediate element being provided removable fastening means (70A, 70B), so that, after the fluid substance(S) has been completely dispensed, a user can disengage the collar (80) from the intermediate element (5) together with the inner container (6) and pump (7), and can replace them with a new intermediate element (5) with pump (7) and inner container filled with fluid substance(S) to be dispensed to be re-coupled to the collar (80) and therefore to the outer container (2), wherein the removable fixing means (70A, 70B) comprise a magnetic coupling.

2. The device according to claim 1, wherein at least one magnetic element (70A) is coupled to the collar (80) and at least one ferromagnetic element (70B) is coupled to the intermediate element (5).

3. The device according to claim 1, wherein the opening (4) and consequently a passage (80A) of the collar (80) are configured to allow an inner container (6, 60) filled with fluid substance(S) to be dispensed to be inserted into the outer container (2).

4. The device according to claim 1, wherein the intermediate element (5) defines a neck (10) having a smaller diameter than the diameter of the opening (4) defined by the free end of said side wall (2B), the neck (10) being provided with a free end (10A) on which rests a first flange (11) of the inner container (6) that is a deformable bag housed in the outer container (2), to the first flange (11) resting a second flange (13) of the pump (7), the device further comprising a nut (14) locked to said neck (10), the first flange (11) and the second flange (13) being sandwiched tightly between said free end (10A) and said nut (14).

5. The device according to claim 4, wherein the nut (14) is locked to the neck (10) by means of a thread or by means of a snap coupling.

6. The device according to claim 1, wherein the intermediate element (5′) defines a cup (61) having, on an inner wall thereof, coupling means for engaging with a neck (62) of the inner container (60), the neck (62) being housed in the cup (61).

7. The device according to claim 6, wherein the top of the cup (61) is defined by a flange wall (25), to the flange wall (25) resting a second flange (13) of the pump, to the second flange (13) of the pump (7), on the opposite side from the flange wall (25) resting the free end (70) of a deformable bag (71) housed in the inner container (60).

8. The device according to claim 6, wherein the coupling means comprise a snap-coupling or a thread (72).

9. The device according to claim 1, wherein the collar (80) has, in cross-section, a groove (90) in which the free edge of said side wall (2B) fits.

10. The device according to claim 1, wherein an outer skirt (80B) of the collar (80) is crimped to an outer surface of said side wall (2B), at an annular groove (2C) of said side wall (2B), or wherein the side wall (2B) is inserted with interference irremovably into said groove (90).

11. The device according to claim 1, wherein said side wall (2B) of the outer container is cylindrical or polygonal, the outer surface of the side wall presenting decorative reliefs or depressions.

12. The device according to claim 1, wherein said side wall (2B) is made in a single piece with the bottom (2A) of the outer container (2).
